(19) United States
(12) Patent Application Publication
(10) Pub. No.: US 2025/0375910 A1
(43) Pub. Date: Dec. 11, 2025

(54) COLD SHEAR MACHINE WITH TWIN CRANK SHAFTS

(71) Applicant: Qingbin WEI, Beijing (CN)

(72) Inventors: Qingbin WEI, Beijing (CN); Dayong NIU, Beijing (CN); Ning WEI, Beijing (CN)

(21) Appl. No.: 19/312,318

(22) Filed: Aug. 28, 2025

Related U.S. Application Data
(63) Continuation of application No. PCT/CN2024/079476, filed on Feb. 29, 2024.

(30) Foreign Application Priority Data
Mar. 3, 2023 (CN) 202310198322.0

(51) Int. Cl. B26D 1/24

(52) U.S. Cl. CPC B26D 1/24

(57) ABSTRACT

Provided is a cold shear machine with twin crank shafts, including cold shear machine box body, a main transmission crankshaft, a connecting rod, and an upper blade holder crankshaft with a same eccentric distance as the main transmission crankshaft, the main transmission crankshaft is connected to the blade holder crankshaft through the connecting rod. When standing by for shearing, the centerline position of the upper blade holder crankshaft is fixed, eccentricities of the main transmission crankshaft and the upper blade holder crankshaft rotate synchronously; when shearing, the eccentricity of the upper blade holder crankshaft is vertically upward, fixed and static relative to the upper blade holder, the centerline of the upper blade holder crankshaft moves in a vertical direction, and the main transmission crankshaft drives the upper blade holder and the upper blade holder crankshaft to move up and down twice the eccentric distance to complete the shearing.

### CROSS-REFERENCE

This application is a continuation of International Application No. PCT/CN2024/079476 with a filling date of Feb. 29, 2024, designating the United states, now pending, and further claims to the benefit of priority from Chinese Application No. 202310198322.0 with a filing date of Mar. 3, 2023. The content of the aforementioned applications, including any intervening amendments thereto, are incorporated herein by reference.

### TECHNICAL FIELD

The present disclosure relates to the technical field of transmission for cold shear machine, in particular to a cold shear machine with twin crank shafts.

### BACKGROUND

Cold shear machine is a device used in the metallurgical industry to shear bar materials, which is used for shearing bar materials on production lines, such as online sizing and cutting off rod/bar stock on continuous production lines. The operation of cold shear machine includes two states: standby for shearing and shearing process. The existing cold shear machine mainly consists of two parts: power transmission mechanism and shearing mechanism. The gearbox is of a start-stop type, and the shearing mechanism adopts the principle of crank connecting rod mechanism, as shown in FIG. 13 and FIG. 14. One rotation of the main transmission crankshaft completes one shearing process. As shown in FIG. 15, the existing cold shear machine transmits motor power to the upper blade holder through a belt, a gearbox, and crank connecting rod mechanism. The high-speed gear shaft of the gearbox is provided with a flywheel, a clutch, a brake, etc, wherein the brake is normally closed, and the upper blade holder is in a high position, standby for shearing. The low-speed shaft of the gearbox is also the main transmission crankshaft of the shearing mechanism. The upper blade holder and the connecting rod are fixed by a pin shaft. At the beginning of shearing, the brake on the high-speed gear shaft is released, the clutch is connected to the flywheel and the high-speed gear shaft for transmission, the gearbox starts to transmit power to the main transmission crankshaft, and the main transmission crankshaft rotates 180 degrees to complete the downward shearing action of the upper blade holder. The main transmission crankshaft continues to rotate 180 degrees to raise and reset the upper blade holder, the entire shearing process is completed, the clutch disconnects the transmission of the flywheel and the high-speed gear shaft, the brake works for breaking, the gearbox stops working, and the main transmission crankshaft stops rotating. At this time, the upper blade holder is in a high position and enters a standby state for shearing. The main transmission crankshaft completes one round of shearing and resetting, during which the upper blade holder moves up and down to reset once, while the lower blade holder remains fixed, thus completing one round of shearing.

However, for the existing cold shear machine, it takes approximately 2 seconds to complete each shearing cycle, during which the gearbox and the shearing mechanism need to perform a start-stop once. This high-frequency start-stop process requires extremely high requirements for the clutch and the brake. Firstly, the action time is short, secondly, the transmission torque is large, consuming a lot of energy. Frequent start-stop has a large impact on the gearbox, reducing the service life of the equipment. Meanwhile, a lot of heat will be generated by the friction plates, which requires specialized fans for cooling, increasing energy consumption. Taking the cold shear machine with 1300 ton as an example, the clutch and brake usually need to be replaced by imported or domestic ones, and the cost of use and maintenance will be high.

### SUMMARY

The technical problem to be solved by the present disclosure is to provide a cold shear machine that can solve the problems of high-frequency start and stop, large mechanical impact, and high energy consumption of existing cold shear machines, thereby overcoming the shortcomings of existing technology.

To solve the above technical problems, the present disclosure discloses a cold shear machine with twin crank shafts, which includes a cold shear machine box body, a main transmission crankshaft, a connecting rod, and an upper blade holder crankshaft with a same eccentric distance as the main transmission crankshaft. The main transmission crankshaft is connected to the blade holder crankshaft through the connecting rod. When standby for shearing, a centerline position of the upper blade holder crankshaft is fixed, eccentricities of the main transmission crankshaft and the upper blade holder crankshaft rotate synchronously; when shearing, the eccentricity of the upper blade holder crankshaft is vertically upward, fixed and static relative to the upper blade holder, the centerline of the upper blade holder crankshaft moves in a vertical direction, and the main transmission crankshaft drives the upper blade holder and the upper blade holder crankshaft to move up and down twice the eccentric distance to complete the shearing.

As a further improvement of the present disclosure, a first outward extending shaft is arranged at an end of an operating side of the main transmission crankshaft, a second outward extending shaft is arranged at an end of an operating side of the upper blade holder crankshaft, one end of the second outward extending shaft is connected to the upper blade holder crankshaft through a crosshead slider, the other end of the second outward extending shaft extends outside of the cold shear machine box body; a transmission mechanism is arranged between the first outward extending shaft and the second outward extending shaft, the upper blade holder crankshaft rotates synchronously with the main transmission crankshaft through the transmission mechanism.

As a further improvement of the present disclosure, a transmission mechanism used for the upper blade holder crankshaft is a gear transmission mechanism. The first outward extending shaft includes a segment of complete gear, a segment of incomplete gear, and an integrated gear shaft. A torque is transmitted between the first outward extending shaft and the main transmission crankshaft through a flange plate containing two-stage spring for damping. One set of springs is used to control contact, the other set is used to control torque, the damping flange is fixed to an end face of the main transmission crankshaft by bolts and pin shafts or flat keys. A second gear and a ratchet disc are arranged at an end of the second outward extending shaft, an intermediate gear shaft is arranged between the first outward extending shaft and the second outward extending shaft, and the intermediate gear shaft is a combination structure of a shaft and an outer gear sleeve. The outer gear sleeve includes a segment of complete gear and two segments of incomplete gear, the outer gear sleeve is in mesh with the second gear all the time, a bushing is arranged between the outer gear sleeve and the shaft, and a shoulder spacer locking nut and a gasket locking outer gear sleeve are arranged on the shaft. The shaft and the outer gear sleeve can rotate freely relative to each other, but an axial position is relatively fixed, the shaft does not rotate, but can perform an axial shift under the control of two hydraulic cylinders, switching between three fixed positions. The axial shift will occur within a window period (greater than 180°) where teeth will not interfere. When shearing, the gear of the first outward extending shaft and the gear of the intermediate gear shaft are in a disengaged state. When the cold shear machine completes shearing, the intermediate gear shaft has already performed an axial shift into place, and the gear of the intermediate gear shaft begins to mesh with the gear of the first outward extending shaft.

As a further improvement of the present disclosure, the cold shear machine with twin crank shafts further includes a controllable automatic locking mechanism, at the moment when the shearing cycle of the cold shear machine begins, the automatic locking mechanism will limit the rotation of the upper blade holder crankshaft and keep the eccentric distance of the upper blade holder crankshaft in a high position. During the shearing process, the upper blade holder locking block slides down to lock the cross copper slider, and automatically unlocks when it moves upward after shearing is completed, as shown in FIG. 3.

As a further improvement of the present disclosure, the cold shear machine with twin crank shafts further includes a locking device for locking a locking block to balance the shearing friction force on the upper blade holder. The locking block is fixed on the connecting rod. Within a range of 0° to 90° rotation of the upper blade holder crankshaft at the beginning of shearing, the locking block is automatically rotated in, and within a range of 90° to 180°, during shearing, the locking block is worked and rotated out, without affecting the normal movement of the shearing machine at other times.

As a further improvement of the present disclosure, the cold shear machine with twin crank shafts further includes a balancing mechanism. The balancing mechanism is controlled by a hydraulic cylinder, configured to detect vertical and horizontal positions of the upper blade holder and perform fine tuning the upper stop position. The hydraulic cylinder is used to balance a downward force acting on the upper blade holder, the upper blade holder crankshaft, and the connecting rod. When standing by for shearing, the hydraulic cylinder will make the upper blade holder close to the upper stop position; when shearing, the hydraulic cylinder is in a released state.

As a further improvement of the present disclosure, the cold shear machine with twin crank shafts further includes a rotation detection mechanism, which is used to detect the rotation of the upper blade holder crankshaft under the action of shear friction force.

As a further improvement of the present disclosure, the existing brake is eliminated, and the cold shear machine with twin crank shafts includes a motor and a gearbox, wherein the gearbox includes a gearbox high-speed shaft and a gearbox low-speed shaft; a flywheel is arranged on the gearbox high-speed shaft, and is connected to the motor through a belt drive; a clutch is arranged on the flywheel, and is used to engage or disengage power transmission between the flywheel and the gearbox high-speed shaft. The clutch is disconnected in the case of shear overload and abnormal conditions. The gearbox low-speed shaft and the main transmission crankshaft are integrated.

By adopting such a design, the present disclosure has at least the following advantages:

With the present disclosure, the transmission structure of traditional cold shear machines is improved. The pin shaft used to connect the upper blade holder in the cold shear machine is replaced with an upper blade holder crankshaft with the same eccentricity as the main transmission crankshaft, and an transmission shaft is connected to the operating side of the upper blade holder crankshaft externally through a cross slider. In the cold shear machine, the main transmission crankshaft and the upper blade holder crankshaft are driven by gears. When the upper blade holder crankshaft is stationary and not rotating, the transmission crankshaft rotates once, and the upper blade holder and the upper blade holder crankshaft are driven downwards by a connecting rod, achieving the shear and reset of shearing blade. When the transmission crankshaft rotates synchronously with the blade holder crankshaft, the upper blade holder and the shearing blade remain stationary, and the cold shear machine is in a state of standby for shearing. The transmission structure of the double-crank shaft in the present disclosure changes the transmission system of the cold shear machine from a high-frequency start-stop type to a continuous operation type, thereby reducing the impact caused by frequent start-stop, making the mechanical operation smoother, more efficient and energy-saving, and reducing equipment manufacturing and maintenance costs. Meanwhile, the use of small motor power and the absence of cooling equipment for the brake and clutch reduce overall energy consumption.

### BRIEF DESCRIPTION OF THE DRAWINGS

The above is only an overview of the technical solution of the present disclosure. In order to have a clearer understanding of the technical means of the present disclosure, the present disclosure provides further detailed illustration in conjunction with the accompanying drawings and specific embodiments.

FIG. 1 is a structural schematic diagram of the assembly of a main transmission crankshaft and a blade holder crankshaft in an embodiment of the present disclosure.

FIG. 2 is a structural schematic diagram of the assembly of the intermediate gear shaft and shift hydraulic cylinder in the embodiment of the present disclosure.

FIG. 3 is a schematic diagram of the assembly of copper cross slider and blade holder crankshaft flat head with different clearances for shearing and non-shearing in the embodiment of the present disclosure.

FIG. 4 is a schematic diagram of the lateral cooperation between the main transmission crankshaft and the blade holder crankshaft in the embodiment of the present disclosure (with a shearing period 0°/360°).

FIG. 5 is a schematic diagram of the lateral cooperation between the main transmission crankshaft and the blade holder crankshaft in the embodiment of the present disclosure (with a shearing period of 90°).

FIG. 6 is a schematic diagram of the lateral cooperation between the main transmission crankshaft and the blade holder crankshaft in the embodiment of the present disclosure (with a shear period of 135°).

FIG. 7 is a schematic diagram of the meshing of the first outward extending shaft, the second outward extending shaft and the intermediate gear transmission in the embodiment of the present disclosure.

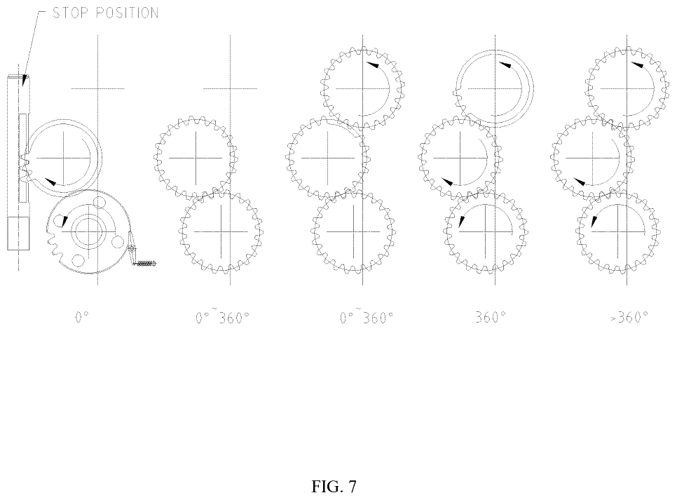

FIG. 8 is a schematic diagram of the intermediate gear shaft shifting to three positions in the embodiment of the present disclosure.

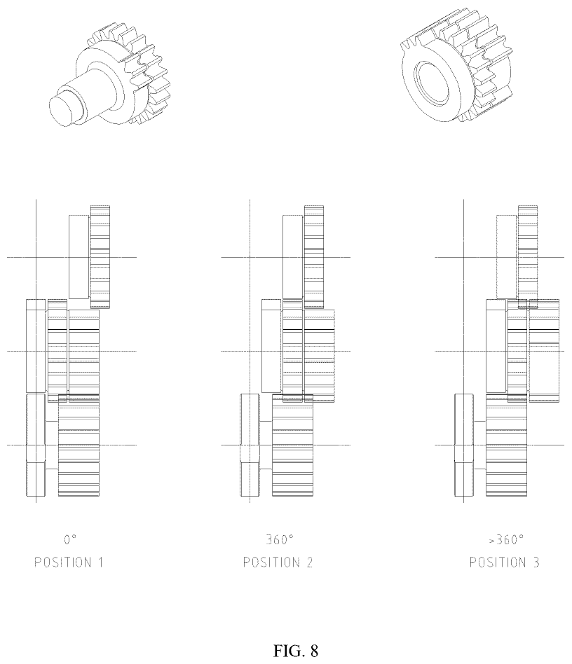

FIG. 9 is a schematic diagram of the transmission between the motor and the gearbox in the embodiment of the present disclosure.

FIG. 10 is a schematic diagram of the start time of shearing in the embodiment of the present disclosure.

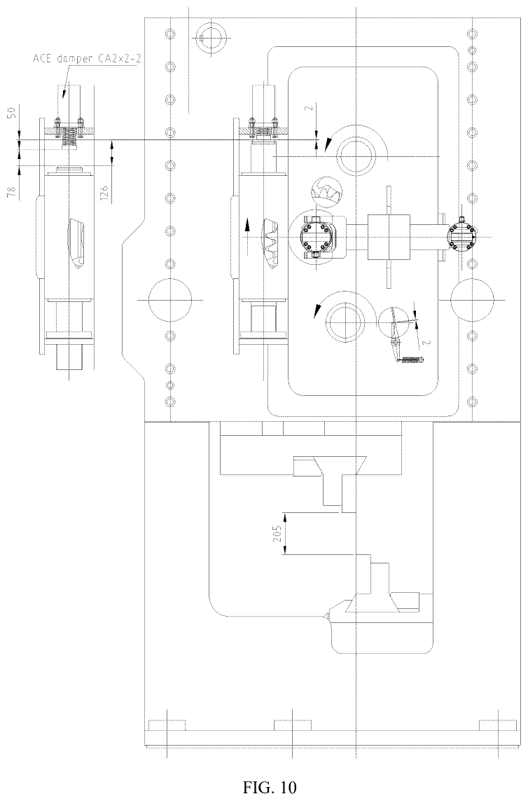

FIG. 11 is a schematic diagram of the assembly of the upper blade holder into the box in the embodiment of the present disclosure (the section line is an enlarged part compared to the original box).

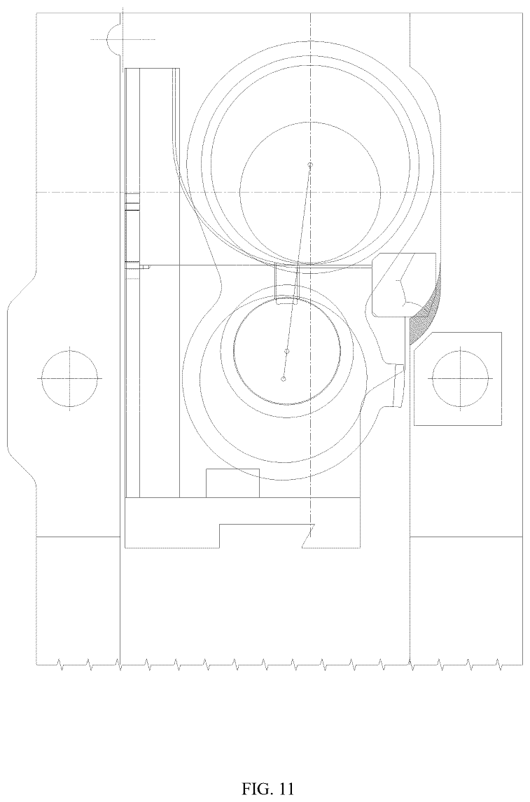

FIG. 12 is an isometric view of the upper blade holder in the embodiment of the present disclosure.

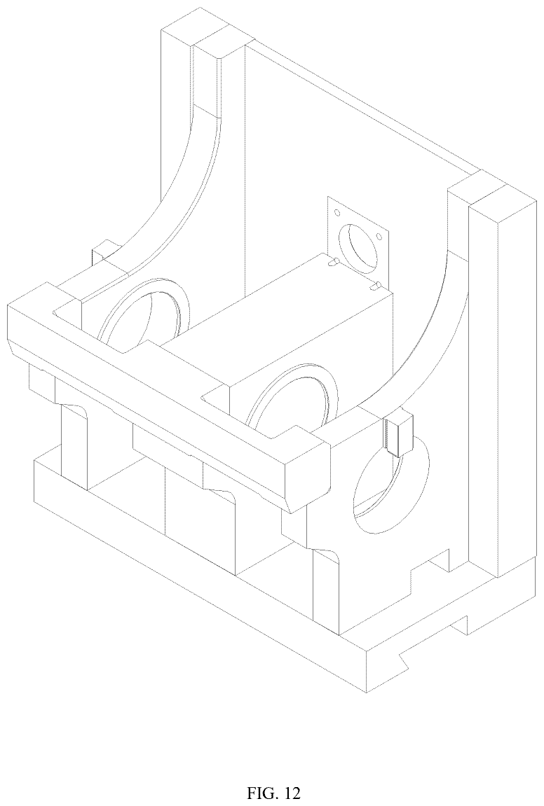

FIG. 13 is a structural schematic diagram of the assembly of the main transmission crankshaft and the pin shaft in a traditional cold shear machine.

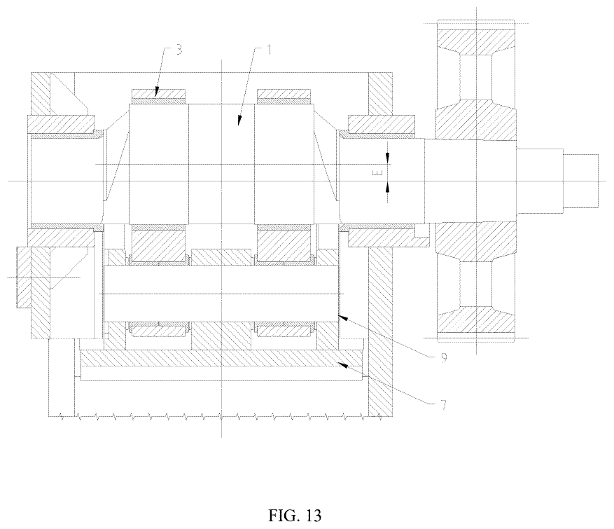

FIG. 14 is a schematic diagram of the lateral structure of the main drive crankshaft and the pin shaft in a traditional cold shear machine.

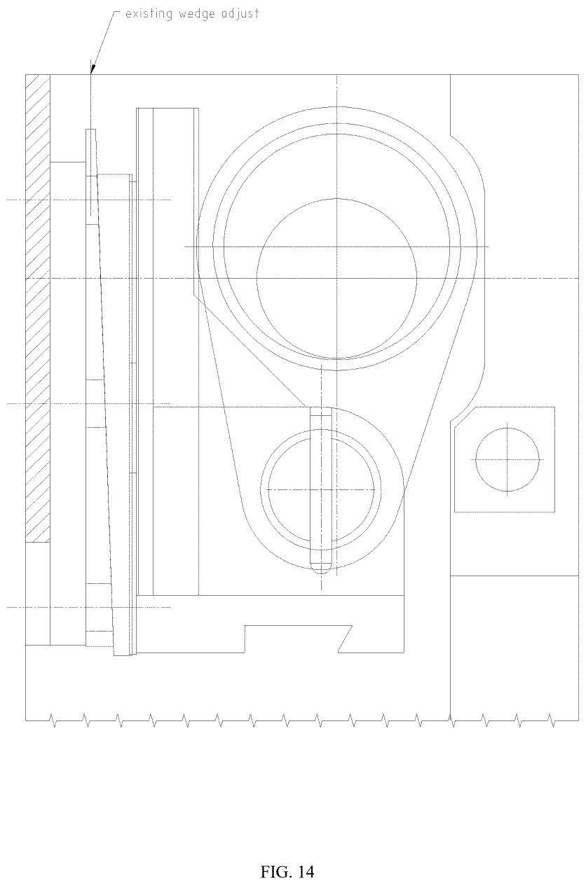

FIG. 15 is a schematic diagram of the transmission between the motor and the gearbox in a traditional cold shear machine.

### REFERENCE NUMBERS IN THE DRAWINGS

1—main transmission crankshaft; 2—first outward extending shaft; 3—connecting rod; 4—second outward extending shaft; 5—upper blade holder crankshaft; 6—cross slider; 7—upper blade holder; 8—intermediate gear shaft; 9—pin shaft; 10—cold shear machine box body; 11—motor; 12—belt drive; 13—flywheel; 14—clutch: 15—gearbox high-speed shaft; 16—brake.

### DETAILED DESCRIPTION OF THE EMBODIMENTS

Examples of the embodiments described in the present disclosure are shown in the accompanying drawings, where identical or similar reference numerals from beginning to end represent identical or similar components or components with identical or similar functions. The embodiments described below with reference to the accompanying drawings are exemplary and are only used to explain the present disclosure, and should not be construed as limiting the present disclosure.

In the description of the present disclosure, it should be noted that unless otherwise specified and limited, the terms “installation”, “connecting”, and “connection” should be broadly understood, for example, they can be fixed connections, detachable connections, or integral connections; it can be a mechanical connection or an electrical connection; it can be directly connected, indirectly connected through an intermediate medium, or connected internally between two components. For ordinary skilled person in the art, the specific meanings of the above terms in the present disclosure can be understood in specific situations.

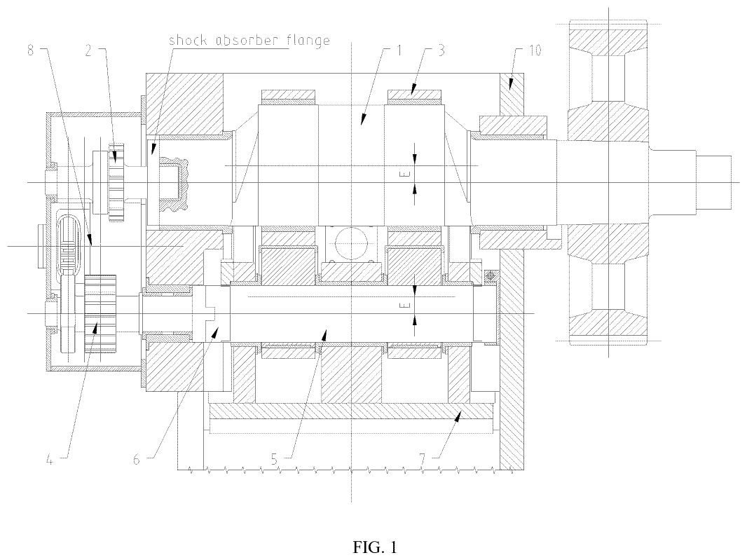

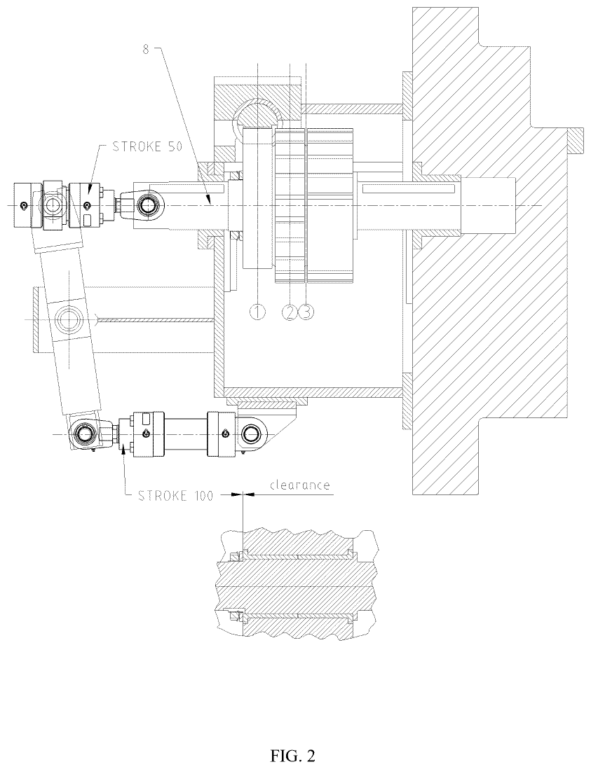

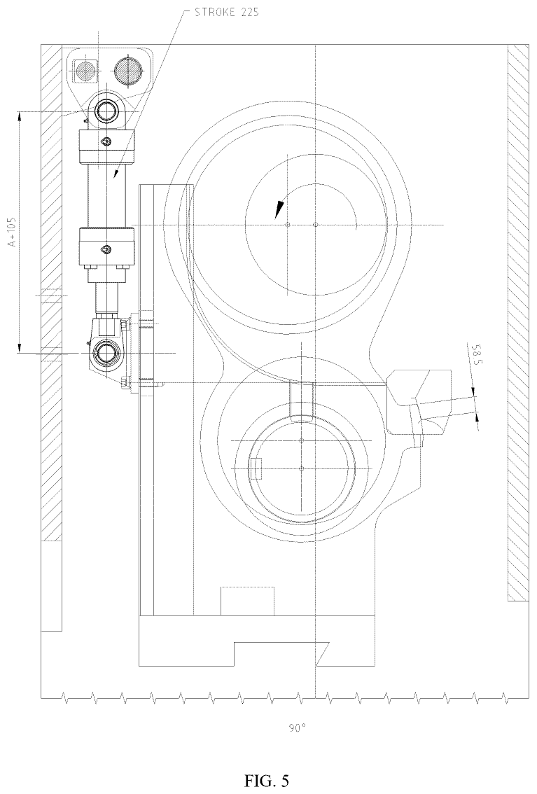

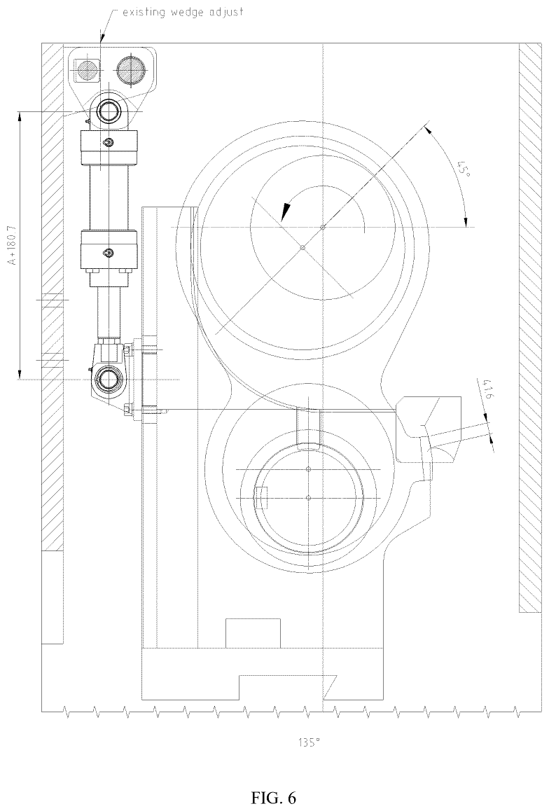

As shown in FIG. 1 to FIG. 6, the dimensions in the drawings are based on a 1300 ton cold shear machine, with an eccentricity of 105 mm, including the selection of the damper from ACE Controls Inc. (Hereinafter referred to as ACE). In this embodiment, it specifically discloses a cold shear machine with twin crank shafts. The cold shear machine with twin crank shafts replaces the fixed non-rotating pin shaft between the traditional connecting rod and the upper blade holder 7 with a rotatable upper blade holder crankshaft 5, which has the same eccentricity as the main transmission crankshaft 1. When standing by for shearing, the upper blade holder crankshaft 5 rotates synchronously with the main transmission crankshaft 1, similarly to the movement of a parallel four-bar linkage, and the upper blade holder 7 is kept still or fluctuates within a small deviation range. When shearing, the upper blade holder crankshaft 5 stops rotating, and the upper blade holder crankshaft 5 is eccentrically stopped directly above, that is, in a high position. At this time, driven by the eccentric rotation of the main transmission crankshaft 1, the upper blade holder crankshaft 5 and the upper blade holder 7 move downward and then return to complete one shearing, and this state is a crankshaft connecting rod mechanism.

In this embodiment, the upper blade holder 7 connected to the upper blade holder crankshaft 5 is raised to reserve a rotating space for the upper blade holder crankshaft 5. The cold shear machine box body 10 is further heightened appropriately to cooperate with the height change of the upper blade holder 7, and the shape is modified appropriately to adapt to some other structural changes at the same time.

Specifically, as shown in FIG. 1, in this embodiment, the cold shear machine with twin crank shafts includes a cold shear machine box body 10, a main transmission crankshaft 1, a connecting rod 3, and an upper blade holder crankshaft 5 with the same eccentric distance E as the main transmission crankshaft 1. The main transmission crankshaft 1 is connected to the blade holder crankshaft through the connecting rod 3. When standing by for shearing, the axis of the upper blade holder crankshaft remains stationary, and the main transmission crankshaft 1 and the upper blade holder crankshaft 5 rotate synchronously; when shearing, the eccentricity of the upper blade holder crankshaft 5 is vertically upward, fixed and static relative to the upper blade holder 7. The centerline of the upper blade holder crankshaft 5 moves in the vertical direction, and the main transmission crankshaft 1 drives the upper blade holder 7 and the upper blade holder crankshaft 5 to move up and down twice the eccentric distance to complete the shearing.

In this embodiment, the synchronous eccentric motion of the main transmission crankshaft 1 and the upper blade holder crankshaft 5 is actually similar to the parallel four-bar linkage. Generally, it can be completed by inertia under the driving of the main transmission crankshaft 1, without the need for external force. However, in this embodiment, due to the starting position angle of the upper blade holder crankshaft 5 approaching the dead center, an auxiliary power is required to assist the transition of the upper transmission crankshaft from a stationary to an operational state.

In more detail, in this embodiment, a first outward extending shaft 2 is arranged at one end of the main transmission crankshaft 1. A torque is transmitted between the first outward extending shaft 2 and the main transmission crankshaft 1 through a flange plate containing two-stage spring for damping. One set of springs is used to control contact, the other set is used to control torque. The damping flange is fixed to the end face of the main transmission crankshaft by bolts and pin shafts or flat keys, making the transmission smoother and reducing noise, very similar to the two-stage damping structure of heavy-duty truck clutch plates. A second outward extending shaft 4 is arranged at the end of the upper blade holder crankshaft 5. One end of the second outward extending shaft 4 is connected to the upper blade holder crankshaft 5 through a cross slider 6, and the other end of the second outward extending shaft 4 extends outside of the cold shear machine box body 10. A transmission mechanism is arranged between the first outward extending shaft 2 and the second outward extending shaft 4, and with the transmission mechanism, the upper blade holder crankshaft 5 rotates synchronously with the main transmission crankshaft 1. When shearing, the second outward extending shaft 4 and the cross slider 6 are in a stationary state, and the upper blade holder crankshaft 5 moves with the upper blade holder 7. After shearing is completed, the second outward extending shaft 4, the cross slider 6, and the upper lade holder crankshaft 5 rotate synchronously, at this moment, the upper lade holder 7 is in a high position and in a stationary state or floating within a small deviation range.

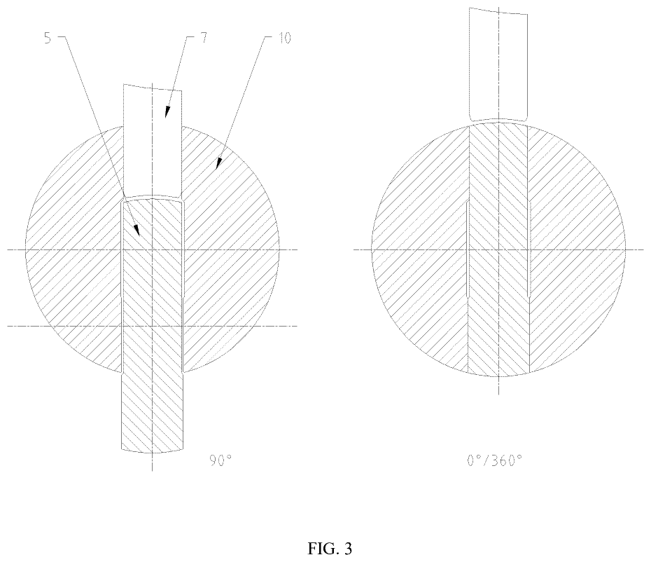

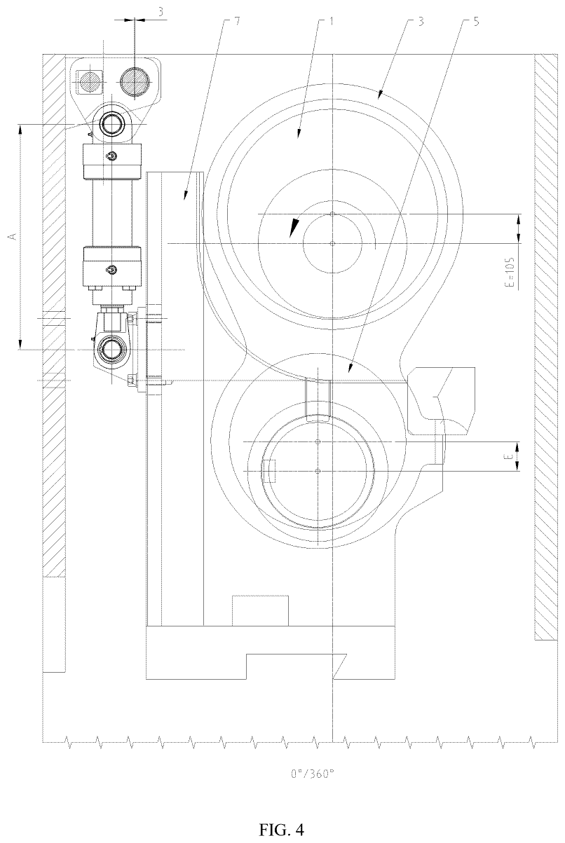

In this embodiment, a transmission mechanism is arranged between the first outward extending shaft 2 and the second outward extending shaft 4, and the blade holder crankshaft is synchronously rotated relative to the main transmission crankshaft 1 by controlling the transmission mechanism. In a preferred embodiment, a gear transmission structure is arranged between the first outward extending shaft 2 and the second outward extending shaft 4. Specifically, as shown in FIG. 1, FIG. 3, and FIG. 4, the first outward extending shaft 2, that is, the first gear shaft including a complete gear section, a incomplete gear section, which is an integral gear shaft. A second gear and a ratchet disc are arranged at the end of the second outward extending shaft 4, and an intermediate gear shaft 8 is arranged between the first outward extending shaft 2 and the second outward extending shaft 4. The intermediate gear shaft 8 is a combination structure of a shaft and an outer gear sleeve, and the outer gear sleeve includes a segment of complete gear and two segments of incomplete gear. The outer gear sleeve engages with the second gear all the time, and a bushing is arranged between the outer gear sleeve and the shaft. A shoulder spacer locking nut and a gasket locking outer gear sleeve are arranged on the shaft. The shaft and the outer gear sleeve can rotate freely relative to each other, but the axial position is relatively fixed. The shaft does not rotate, but can perform axial shift under the control of two hydraulic cylinders, switching between three fixed positions. The axial shift will occur within a window period (greater than 180°) where the teeth will not interfere. When shearing, the first gear and the inner gear of the intermediate gear shaft are in a disengaged state. When the cold shear machine completes shearing, the intermediate gear shaft 8 has already been moved into place, and the outer gear of the intermediate gear shaft begins to mesh with the gear of the first outward extending shaft 2.

In this embodiment, boxes for sealing are arranged on the first outward extending shaft 2, the second outward extending shaft 4, and the gear transmission part. At the same time, the corresponding structures such as bearings, shaft sleeves, and lubrication will be added. The movement of the intermediate gear shaft 8 can be driven by a hydraulic cylinder, and the above can be adapted according to the component structure, which will not be described in detail here for brevity.

The cold shear machine with twin crank shafts further includes a controllable automatic locking mechanism. At the moment when the shearing cycle of the cold shear machine begins, the automatic locking mechanism will limit the rotation of the upper blade holder crankshaft 5 and keep the eccentricity of the upper blade holder crankshaft 5 in a high position. It means that the intermediate gear shaft performs an axial shift to a fixed position 1, and the incomplete gear of the intermediate gear shaft meshes with the rack at a fixed position. At the beginning of meshing, the stroke of about 78 mm is unloaded or very small (due to the gravity and friction of the rack, etc.). Afterwards, the damper stroke of ACE is about 48 mm, with an allowance of about 2 mm (in the forward direction). The preliminary selection of damper is Model: CA2x2-2. Meanwhile, the ratchet of the second outward extending shaft 4 will also be locked by the pawl, and the pawl will also have an allowance of about 2 mm (in the return direction). When starting to shear, the eccentric of the upper blade holder crankshaft 5 is located at a high position, and the intermediate gear shaft 8 is just out of mesh with the gear of the first outward extending shaft 2. When returning to the start shearing position after completing the shearing, it must out of meshing and will not affect the rotation of the upper blade holder crankshaft 5. At a certain time in the shearing cycle (about 40°), the intermediate gear shaft 8 will shift to position 2 for the to-be-sheared time. At this time, the rack will reset under the action of the return spring force of the buffer and self weight, and there will be a rubber pad to buffering. After a certain time (about 40°) when the first outward extending shaft 2 meshes with the intermediate gear shaft 8, the intermediate gear shaft 8 will shift to position 3, achieving complete meshing of the three gear shafts.

The cold shear machine with twin crank shafts further includes a locking device for locking the locking block to balance the shearing friction force on the upper blade holder, so as to fixed the locking block on the connecting rod. Within a range of 0° to 90° at the beginning of shearing cycle, the locking block is automatically rotated in, and within a range of 90° to 180° during shearing, the locking block is worked and rotated out, without affecting the normal movement of the shearing machine at other times.

Copper sliders are further arranged on the transmission side of the upper blade holder crankshaft, only to provide better guidance for the shearing process to the upper blade holder crankshaft. At the beginning of the shearing cycle, the copper sliders on both sides will be locked by the upper blade holder and cannot rotate, only moving slightly along the horizontal direction with the upper blade holder. When standing by for shearing, the copper sliders also move back and forth within a certain range in the horizontal direction.

Further, the cold shear machine with twin crank shafts of this embodiment includes a balancing mechanism. The balancing mechanism is controlled by a hydraulic cylinder, configured to detect the vertical and horizontal positions of the upper blade holder, and performs fine tuning on the upper stop position. One end of the hydraulic cylinder is fixed to the box body and the other end of the hydraulic cylinder is fixed to the upper blade holder. An eccentric shaft will be adjusted at the hinge point fixed to the box body, the eccentric shaft extends out of the shearing machine box body and is operated by a manual or electric turbine worm box for initial installation and later fine adjustment. The hydraulic cylinder is used to balance the downward force, such as gravity and centrifugal force, on the upper blade holder 7, the upper blade holder crankshaft 5, and the connecting rod. When standing by for shearing, the hydraulic cylinder will make the upper blade holder 7 close to the upper stop position; when shearing, the hydraulic cylinder is in a released state.

In addition, the cold shear machine with twin crank shafts further includes a rotation detection mechanism, which is used to detect the rotation of the upper blade holder crankshaft 5 under the action of shear friction force, and also reflect the wear of the locking block, preventing the locking block from being excessively worn and damaging the equipment.

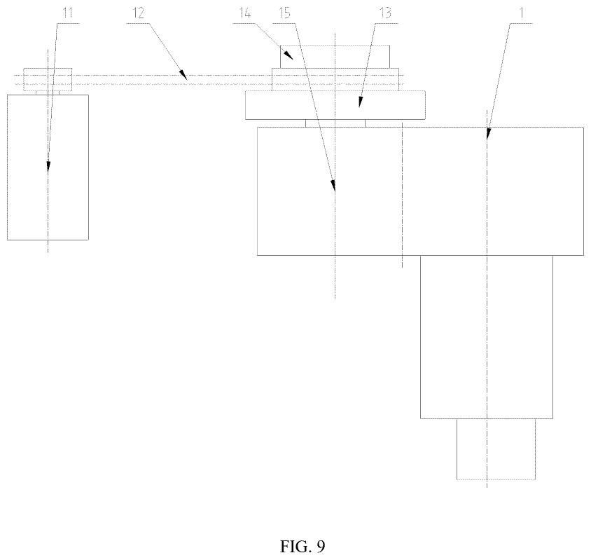

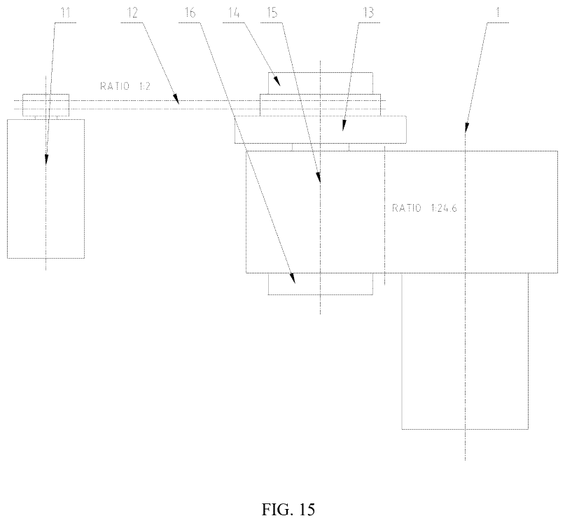

Further, as shown in FIG. 9 and FIG. 15, the cold shear machine with twin crank shafts includes a motor 11 and a gearbox, wherein the gearbox includes a gearbox high-speed shaft 15 and a gearbox low-speed shaft. A flywheel 13 is arranged on the gearbox high-speed shaft 15, and is connected to the motor 11 through a belt drive 12. A clutch 14 is arranged on the flywheel 13, and is used to engage or disengage the power transmission between the flywheel 13 and the gearbox high-speed shaft 15. The gearbox low-speed shaft is the main transmission crankshaft 1. Compared with traditional cold shear machines, in this embodiment, the brake 16 of the gearbox high-speed shaft 15 is removed, the corresponding cooling fan structure is also removed, and the function of the clutch 14 has also changed. In this embodiment, the clutch 14 becomes a safety clutch with a very low working frequency, which is used for both overload clutch of the shear force and abnormal clutch during non shear processes. By adopting the structure of the eccentric cold-shearing in this embodiment, the power of motor 11 can be reduced, therefore energy consumption can be reduced. Taking the cold shear machine with 1300 ton as an example, removing the cooling fan system corresponding to the brake and the clutch can save energy by more than 20% even without considering the removal of the cooling fan, while maintaining the same shearing capacity.

After removing the brake, at the same time, it can become a turning gear position in the original brake position, which is convenient for maintenance and repair in some special positions.

The above description is only the preferred embodiment of the present disclosure and does not limit the present disclosure in any form. Those skilled in the art may make some simple modifications, equivalent changes, or modifications using the disclosed technical content, all of which fall within the scope of the present disclosure.

What is claimed is:

1. A cold shear machine with twin crank shafts, comprising a cold shear machine box body, a main transmission crankshaft, a connecting rod, and an upper blade holder crankshaft with a same eccentric distance as the main transmission crankshaft, the main transmission crankshaft is connected to the blade holder crankshaft through the connecting rod; when standby for shearing, a centerline position of the upper blade holder crankshaft is fixed, eccentricities of the main transmission crankshaft and the upper blade holder crankshaft rotate synchronously; when shearing, the eccentricity of the upper blade holder crankshaft is vertically upward, fixed and static relative to the upper blade holder, the centerline of the upper blade holder crankshaft moves in a vertical direction, and the main transmission crankshaft drives the upper blade holder and the upper blade holder crankshaft to move up and down twice the eccentric distance to complete the shearing.

2. The cold shear machine with twin crank shafts according to claim 1, wherein a first outward extending shaft is arranged at an end of an operating side of the main transmission crankshaft, a second outward extending shaft is arranged at an end of an operating side of the upper blade holder crankshaft, one end of the second outward extending shaft is connected to the upper blade holder crankshaft through a cross slider, an other end of the second outward extending shaft extends outside of the cold shear machine box body; a transmission mechanism is arranged between the first outward extending shaft and the second outward extending shaft, the upper blade holder crankshaft rotates synchronously with the main transmission crankshaft through the transmission mechanism.

3. The cold shear machine with twin crank shafts according to claim 2, wherein a transmission mechanism used for the upper blade holder crankshaft is a gear transmission mechanism; the first outward extending shaft comprises a segment of complete gear, a segment of incomplete gear and an integrated gear shaft; a torque is transmitted between the first outward extending shaft and the main transmission crankshaft through a flange plate containing two-stage springs for damping, one set of springs is used to control contact, the other set of springs is used to control torque, and the damping flange is fixed to an end face of the main transmission crankshaft by bolts and pin shafts or flat keys; a second gear and a ratchet disc are arranged at an end of the second outward extending shaft, an intermediate gear shaft is arranged between the first outward extending shaft and the second outward extending shaft, the intermediate gear shaft is a combination structure of a shaft and an outer gear sleeve, the outer gear sleeve comprises a segment of complete gear and two segments of incomplete gear, the outer gear sleeve is in mesh with the second gear all the time, a bushing is arranged between the outer gear sleeve and the shaft, a shoulder spacer locking nut and a gasket locking outer gear sleeve are arranged on the shaft, the shaft and the outer gear sleeve are capable of rotating freely relative to each other, with an axial position relatively fixed; the shaft does not rotate, but performs an axial shift under the control of two hydraulic cylinders, switching between three fixed positions; the axial shift occurs within a window period (greater than 180°) during which teeth do not interfere; when shearing, a gear of the first outward extending shaft and a gear of the intermediate gear shaft are in a disengaged state, when the cold shear machine completes shearing, the intermediate gear shaft has already performed an axial shift into place, and the gear of the intermediate gear shaft begins to mesh with the gear of the first outward extending shaft.

4. The cold shear machine with twin crank shafts according to claim 1, wherein the cold shear machine with twin crank shafts further comprises a controllable automatic locking mechanism, at the moment when the shearing cycle of the cold shear machine begins, the automatic locking mechanism limits the rotation of the upper blade holder crankshaft and keeps an eccentricity of the upper blade holder crankshaft in a high position.

5. The cold shear machine with twin crank shafts according to claim 1, wherein the cold shear machine with twin crank shafts further comprises a locking device for locking a locking block to balance the shearing friction force on the upper blade holder, the locking block is fixed on the connecting rod, within a range of 0° to 90° rotation of the upper blade holder crankshaft at the beginning of shearing, the locking block automatically is rotated in, and within a range of 90° to 180° during shearing, the locking block is worked and rotated out, without affecting the normal movement of the shearing machine at other times.

6. The cold shear machine with twin crank shafts according to claim 1, wherein the cold shear machine with twin crank shafts further comprises a balancing mechanism, the balancing mechanism is controlled by a hydraulic cylinder, configured to detect vertical and horizontal positions of the upper blade holder and perform fine tuning on an upper stop position; the hydraulic cylinder is used to balance a downward force acting on the upper blade holder, the upper blade holder crankshaft, and the connecting rod; when standing by for shearing, the hydraulic cylinder makes the upper blade holder close to the upper stop position; when shearing, the hydraulic cylinder is in a released state.

7. The cold shear machine with twin crank shafts according to claim 1, wherein the cold shear machine with twin crank shafts further comprises a rotation detection mechanism, and the rotation detection mechanism is used to detect the rotation of the upper blade holder crankshaft under the action of shear friction force.

8. The cold shear machine with twin crank shafts according to claim 1, further comprising a motor and a gearbox, wherein the gearbox comprises a gearbox high-speed shaft and a gearbox low-speed shaft, a flywheel is arranged on the gearbox high-speed shaft, and is connected to the motor through a belt drive; without a brake, a clutch is arranged on the flywheel, and is used to engage or disengage power transmission between the flywheel and the gearbox high-speed shaft, and the gearbox low-speed shaft and the main transmission crankshaft are integrated.
